(19) United States
(12) Patent Application Publication
(10) Pub. No.: US 2009/0290951 A1
(43) Pub. Date: Nov. 26, 2009

(54) Sleeve For a T-Bolt and a Sleeve and T-Bolt Combination to Prevent T-Bolt Rotation

(75) Inventor: Kenneth Blom, Galten (DK)

Correspondence Address: THE NATH LAW GROUP, 112 South West Street, Alexandria, VA, 22314, US

(73) Assignee: Aage V. Kjærs Maskinfabrik A/S, Galten (DK)

(21) Appl. No.: 12/309,588

(22) PCT Filed: Jul. 31, 2006
(86) PCT No.: PCT/DK2006/000427

§ 371 Date: Jan. 23, 2009

(51) Int. Cl. F16B 39/02; F16B 35/04

(52) U.S. Cl. 411/82; 411/104

(57) ABSTRACT

A sleeve (1) for a T-bolt (21) comprises a longitudinally extending part (2) having a first end (3) and a second end (4), and a longitudinal axis (5) extending from the first end (3) to the second end (4). The longitudinally extending part (2) has a through-going interior bore (6) extending along said longitudinal axis (5) from said first end (3) to said second end (4). The longitudinally extending part (2) has an exterior surface (7) with a shape adapted to engage a recess of an object so that the sleeve (1) is rotationally retained about the longitudinal axis (5), when said longitudinally extending part (2) is inserted in said recess of said object. The sleeve (1) additionally comprises retaining means for retaining a T-bolt (21) so that said T-bolt (21) is rotationally retained about the longitudinal axis (5), when the T-bolt (21) is inserted in the bore (6) of said sleeve (1).

### TECHNICAL FIELD

The present invention relates to a sleeve for a T-bolt, said sleeve comprising a longitudinally extending part having a first and a second end, and a longitudinal axis extending from the first end to the second end, said longitudinally extending part having a through-going interior bore extending along said longitudinal axis from said first end to said second end. The invention also relates to a T-bolt and sleeve combination.

### BACKGROUND ART

A mechanical joint is a time-saving and easily installed joint that has to ensure a long-term, trouble-free performance. Mechanical joints as described in the ANSI/AWWA C111 standard are one of the primary methods of joining either Ductile-Iron or PVC pipes in the United States. The mechanical joints are for instance used for pipes on water, gas or other fluid distribution/transmission pipe lines. Such a joint comprises a socket or a bell, a gland, a gasket and T-bolts.

A common problem in assembling this type of joint on a valve is that the T-bolts can rotate out of the mechanical joint recess of the valve during assembly when using power wrenches or manual wrenches. Valves have recesses instead of holes for T-bolts of the mechanical joint because the body of the valve, particular in the case of gate valves, interferes when trying to slide the T-bolt into a hole. After the pipe is inserted into the bell, the T-bolt is used to pull the gland tight. This causes the gasket to expand and seal the pipe.

If the T-bolt has rotated during assembly, one end portion of the T-bolt head may no longer abut the flange of the valve, which weakens the joint and in worst case will make the mechanical joint disengage from the valve.

### DISCLOSURE OF INVENTION

It is the object of the invention to provide a sleeve for a T-bolt, which is applicable for T-bolts used in for instance mechanical joints, and which ensures that the T-bolt does not rotate during assembly or use.

This is according to invention obtained by said longitudinally extending part having an exterior surface with a shape adapted to engage a recess of an object so that the sleeve is rotationally retained about the longitudinal axis, when said longitudinally extending part is inserted in said recess of said object, and wherein the sleeve comprises retaining means for retaining a T-bolt so that said T-bolt is rotationally retained about the longitudinal axis, when the T-bolt is inserted in the bore of said sleeve.

The sleeve thus ensures, when inserted in the recess of a valve, that the sleeve does not rotate in the recess. The retaining means ensure that the T-bolt does not rotate relative to the sleeve, thereby overall ensuring that the T-bolt does not rotate out of the recess.

According to a particular embodiment of the sleeve, the interior bore is threaded, so that a threaded bolt can be secured to the sleeve via the threads.

In a preferred embodiment of the sleeve, the exterior surface of the longitudinally extending part comprises at least a first substantially plane surface and a second substantially plane surface. If the sleeve is inserted into a recess with a corresponding first plane surface and a second plane surface, this yields a simple method to ensure that the sleeve is rotationally retained in the recess. Preferably, the first substantially plane surface and the second substantially plane surface are mutually parallel. More preferably, the two surfaces are substantially parallel to the longitudinal axis.

According to a particularly preferred embodiment of the sleeve according to the invention, the retaining means comprises a bolt head engaging part at the second end of the longitudinally extending part, the shape of said bolt head engaging part being adapted to retain the head of the T-bolt, when said T-bolt is inserted through the bore of the longitudinally extending part. This provides a simple method to ensure that the bolt does not rotate about the longitudinal axis and that the head of the bolt has the correct orientation with respect to the recess.

According to a preferred embodiment of the sleeve, the bolt head engaging part is oblong and oriented along a transverse axis substantially orthogonal to the two parallel surfaces. It can thereby be ensured that the head of the T-bolt is oriented along for instance the tangent of a circular flange of a valve having a radially extending recess.

According to a particular embodiment of the invention, the bolt head engaging part has a first surface adapted to abut the bolt head, when said bolt is inserted in the bore of the sleeve, said first surface having a constant profile along the transverse axis. Thereby, it is possible to efficiently retain the head of a T-bolt having a substantially constant cross-section.

In an embodiment according to the invention, said sleeve is made of plastic. In an alternative embodiment according to the invention, said sleeve is made of a metal or a metal alloy.

The object of the invention is also obtained by a T-bolt and sleeve combination comprising one of the afore-mentioned sleeves and a T-bolt comprising an oblong head with a first end portion and a second end portion, and a threaded elongated shaft adapted to being inserted in the bore of the sleeve.

According to a preferred embodiment, the T-bolt and sleeve are mutually fastened by use of an adhesive, such as glue. According to another preferred embodiment, the T-bolt and sleeve are welded together. In both embodiments, the sleeve need not comprise the bolt head retaining part, since the sleeve and T-bolt are mutually fastened. In this case, however, it is essential that the sleeve is correctly oriented with respect to the bolt head so that the bolt head is correctly oriented with respect to the recess, when the sleeve is inserted in the recess.

### BRIEF DESCRIPTION OF THE DRAWING

The invention is explained in detail below with reference to the drawing, in which

FIG. 1 shows a first side view of a sleeve and T-bolt combination according to the invention,

FIG. 2 a second side view of the same sleeve and T-bolt combination according to the invention, rotated 90 degrees compared to FIG. 1,

FIG. 3 a third side view of the same sleeve and T-bolt combination according to the invention, rotated 180 degrees compared to FIG. 1,

FIG. 4 a top view of the same sleeve and T-bolt combination according to the invention,

FIG. 5 a view of a mechanical joint comprising a sleeve and T-bolt combination fastened to a valve of a fire hydrant, and

FIG. 6 a side view of a second embodiment of a sleeve and T-bolt combination according to the invention.

### BEST MODE FOR CARRYING OUT THE INVENTION

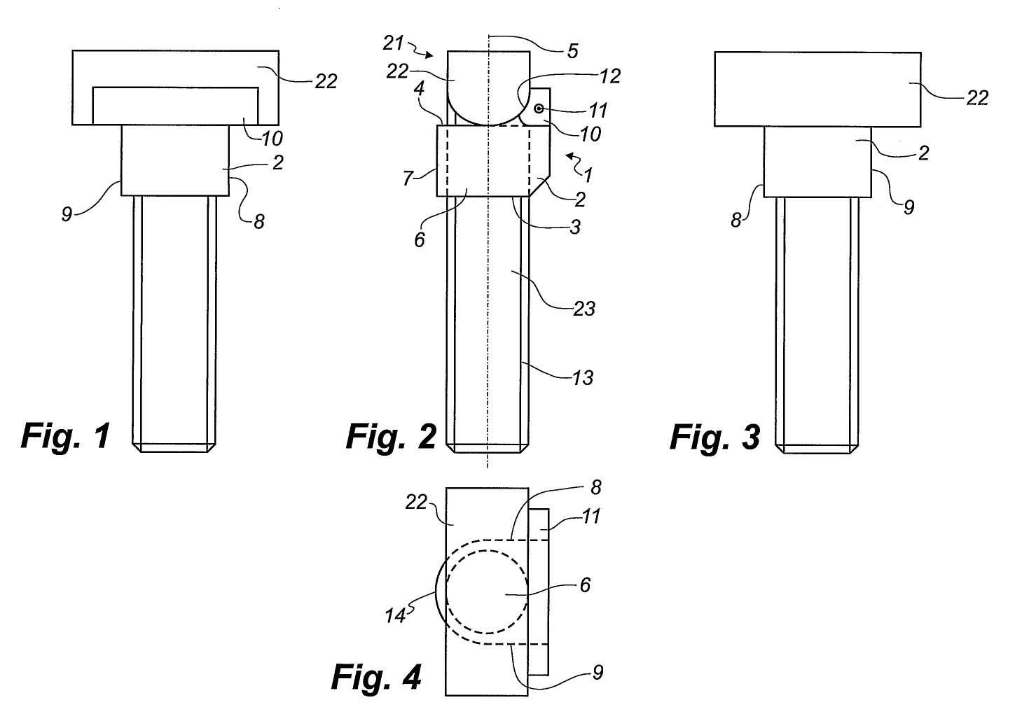

FIGS. 1-3 show a sleeve 1 and T-bolt 21 combination according to the invention seen from three different sides, where the view of FIG. 2 is rotated 90 degrees compared to the view of FIG. 1, and FIG. 3 is rotated 180 degrees compared to the view of FIG. 1. FIG. 4 shows a top view of the sleeve 1 and T-bolt 21 combination. The sleeve 1 comprises a longitudinally extending part 2 having a first end 3 and a second end 4. The longitudinally extending part 2 is oriented along a longitudinal axis 5. A bore 6 extends through the sleeve 1 from the first end 3 to the second end 4 along the longitudinal axis 5. The sleeve has an exterior surface 7 having a shape adapted to engage a recess of an object, such as a recess in a flange of a fire hydrant valve. The exterior surface 7 has a first plane surface 8 and a second plane surface 9. The two plane surfaces 8 and 9 are mutually parallel and parallel to the longitudinal axis 5. Additionally, the exterior surface 7 has a rounded lateral surface 14 connecting the first plane surface 8 and the second plane surface 9.

The sleeve 1 additionally comprises a bolt head retaining part 10 disposed at the second end 4 of the sleeve 1. The bolt head retaining part 10 is oblong and oriented along a transverse axis 11 perpendicular to and laterally spaced from the longitudinal axis 5. The bolt head retaining part 10 has a first surface 12, which is adapted to abut a bolt head of a bolt inserted in the sleeve 1.

A T-bolt 21 is inserted through the bore 6 of the sleeve 1. The T-bolt 21 comprises an oblong head 22 and an elongated threaded 13 shaft 23 inserted through the bore 6 of the sleeve 1. The head 22 of the T-bolt is shaped so that it abuts the first surface 12 of the bolt head retaining part 10, when the T-bolt 21 is fully inserted in the sleeve 1. Thereby, it is ensured that the oblong head 22 of the T-bolt 21 can not rotate relative to the sleeve 1. In this particular embodiment, the bottom of the head 22 of the T-bolt 21 is rounded and the first surface 12 of the bolt head retaining part 10 of the sleeve 1 is correspondingly rounded. However, it is obvious to a person skilled in the art that a variety of shapes is possible in order for the bolt head retaining part 22 to rotationally retain the bolt head 21.

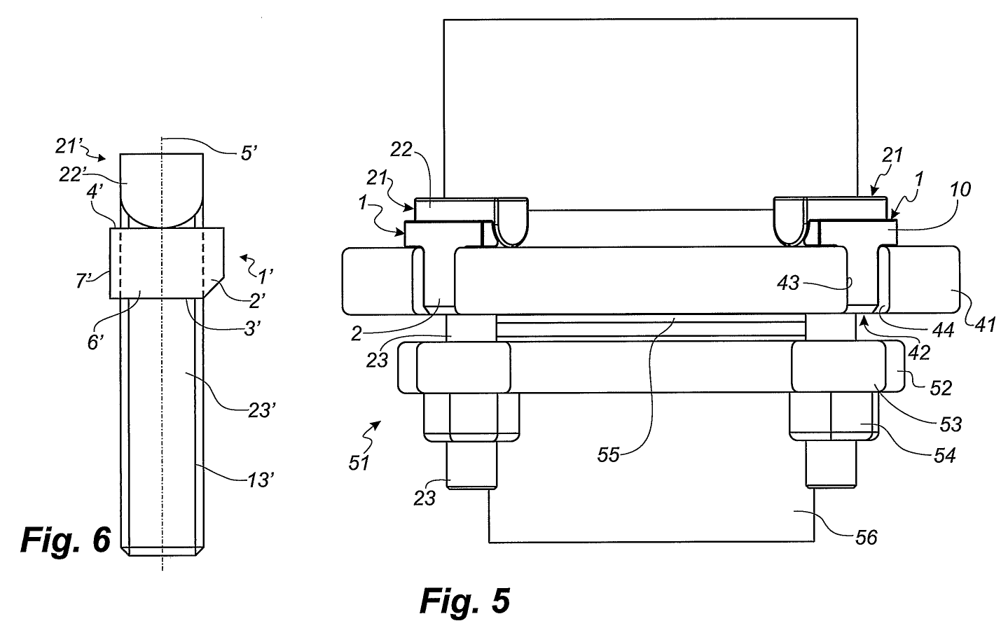

FIG. 5 shows a mechanical joint 51 connected to a valve flange 41 of a fire hydrant. The flange 41 has a number of radially extending recesses 42, each having a first plane recess surface 43 and second plane recess surface 44. A sleeve 1 together with a T-bolt 21 is inserted in all of the recesses 42. The inner surfaces of the recess are shaped to accommodate the sleeve 1. Thus, the first recess surface 43 engages the first surface 8 of the sleeve 1, and the second recess surface 44 engages the second surface 9 of the sleeve 1. Preferably, the recesses 42 also have a rounded bottom portion in order to abut the rounded lateral surface 14 of the sleeve 1. Thereby, it is further ensured that the sleeve 1 is rotationally retained about the longitudinal axis 5, when inserted in the recess 42. It is, however, sufficient that the two plane surfaces 8 and 9 of the sleeve 1 engage the plane recess surfaces 43 and 44, and that the lateral surface 14 does not necessarily have to abut the bottom portion of the recess 42. Also, other shapes for the exterior surface 7 of the sleeve 1 and the shape of the recess 42 can be anticipated in order to rotationally retain the sleeve 1 in the recess 42.

The mechanical joint 51 comprises a number of sleeve 1 and T-bolt 21 combinations, a flange 52 having a number of ears 53 with openings, a number of nuts 54, and a gasket 55. The flange 52 is connected to a pipe 56. The elongated shafts 23 of the T-bolts are each inserted through the bore 6 of the sleeve 1 and through an opening in each ear 53 positioned on the rim of the flange 52 of the mechanical joint 51. The mechanical joint 51 is tightened to the flange 41 of the fire hydrant by tightening the nuts 54 to the threaded shaft 23 of the T-bolts 21 so that the gasket 55 is tightly sealed to the flange 41 of the fire hydrant.

Conventional mechanical joints do not make use of sleeves. Thereby, the T-bolts have a tendency to rotate out of the recesses, especially when power wrenches are used for tightening the nuts. Thereby, the retention force of the bolt head is decreased, since only one end portion of the oblong T-bolt head abuts the inner surface of the flange. This will in worst case make the mechanical joint disengage from the flange of the fire hydrant.

The sleeves 1 according to the invention, however, each have a bolt head retaining part 10, which ensure that the heads 22 of the T-bolts 21 are rotationally retained about the longitudinal axis 5, when tightening the mechanical joint 51. Thereby, it is ensured that both end portions of the oblong bolt head 22 abut the inner surface of the fire hydrant flange 41, thereby maximising the retention force of the mechanical joint 51.

However, the sleeve 1 need not have the bolt head retaining part 10 if the sleeve 1 is fastened to the T-bolt 21 by for instance gluing or welding the two parts together. In this case, it only has to be ensured that the sleeve 1 is fastened to the T-bolt 21 in such a way that the oblong bolt head 22 has the correct orientation with respect to the recess 42, when the sleeve 1 with the T-bolt 21 is inserted in the recess 42 of the flange 41. This second embodiment is shown in FIG. 6, where like numerals correspond to like parts of the first embodiment, and the shown view corresponds to the view of the first embodiment in FIG. 2.

The invention has been described with reference to a preferred embodiment. However, the scope of the invention is not limited to the illustrated embodiment, and alterations and modifications can be carried out without deviating from said scope of the invention. The exterior surface of the sleeve 1 and the shape of the recess 42 can for instance be tapered so as to ensure that the sleeve 1 is radially retained in the recess 42. Furthermore, the sleeve 1 and the recess 42 can be tapered along the longitudinal axis 5, thereby ensuring that the sleeve 1 is axially retained in the recess 42.

### LIST OF REFERENCE NUMERALS

1 sleeve
2 longitudinal extending part
3 first end
4 second end
5 longitudinal axis
6 bore
7 exterior surface
8 first plane surface
9 second plane surface
10 bolt head engaging part
11 transverse axis
12 first surface of bolt head engaging part
13 thread
14 rounded lateral surface
21 T-bolt
22 bolt head
23 elongated shaft
41 flange
42 recess
43 first plane recess surface
44 second plane recess surface
51 mechanical joint
52 flange
53 loop
54 nut
55 gasket
56 pipe

1. A sleeve (1) for a T-bolt (21), said sleeve (1) comprising
a longitudinally extending part (2) having a first end (3) and a second end (4), and a longitudinal axis (5) extending from the first end (3) to the second end (4),
said longitudinally extending part (2) having a through-going interior bore (6) extending along said longitudinal axis (5) from said first end (3) to said second end (4), wherein
said longitudinally extending part (2) having an exterior surface (7) with a shape adapted to engage a recess of an object so that the sleeve (1) is rotationally retained about the longitudinal axis (5), when said longitudinally extending part (2) is inserted in said recess of said object, and wherein the sleeve (1) comprises
retaining means for retaining a T-bolt (21) so that said T-bolt (21) is rotationally retained about the longitudinal axis (5), when the T-bolt (21) is inserted in the bore (6) of said sleeve (1).

2. A sleeve (1) according to claim 1, wherein the interior bore (6) is threaded.

3. A sleeve (1) according to claim 1, wherein the exterior surface (7) of the longitudinally extending part (2) comprises at least a first substantially plane surface (8) and a second substantially plane surface (9).

4. A sleeve (1) according to claim 3, wherein the first substantially plane surface (8) and the second substantially plane surface (9) are mutually parallel.

5. A sleeve (1) according to claim 1, wherein the retaining means comprises a bolt head engaging part (10) at the second end (4) of the longitudinally extending part (2), the shape of said bolt head engaging part (10) being adapted to retain the head (22) of the T-bolt (21), when said T-bolt (21) is inserted through the bore (6) of the longitudinally extending part (2).

6. A sleeve (1) according to claim 5, wherein the bolt head engaging part (10) is oblong and oriented along a transverse axis (11) substantially orthogonal to the two parallel surfaces.

7. A sleeve (1) according to claim 5, wherein the bolt head engaging part (10) has a first surface (12) adapted to abut the bolt head (22), when said bolt (21) is inserted in the bore (6) of the sleeve (1), said first surface (12) having a constant profile along the transverse axis (11).

8. A sleeve (1) according to claim 1, wherein said sleeve (1) is made of plastic.

9. A sleeve (1) according to claim 1, wherein said sleeve (1) is made of a metal or a metal alloy.

10. A T-bolt (21) and sleeve (1) combination comprising a sleeve (1) according to claim 1 and a T-bolt (21) comprising an oblong head (22) with a first end portion and a second end portion, and a threaded elongated shaft (23) adapted to being inserted in the bore (6) of the sleeve (1).

11. A T-bolt (21) and sleeve (1) combination according to claim 10, wherein the retaining means is an adhesive, such as glue, used for mutually fastening the T-bolt and the sleeve (1).

12. A T-bolt (21) and sleeve (1) combination according to claim 10, wherein the retaining means is a welding for mutually fastening the T-bolt (21) and the sleeve (1).
